(19) United States
(12) Patent Application Publication
(10) Pub. No.: US 2006/0068241 A1
(43) Pub. Date: Mar. 30, 2006

(54) Information processing apparatus system, fuel cell unit, and display method thereof

(75) Inventor: Hideaki Tanaka, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/239,241

(22) Filed: Sep. 30, 2005

(30) Foreign Application Priority Data
Sep. 30, 2004 (JP) 2004-289205

(51) Int. Cl. H01M 8/04

(52) U.S. Cl. 429/12; 429/90

(57) ABSTRACT

An information processing apparatus system is provided which is capable of precisely and rapidly displaying fuel management information including a residual quantity of a fuel and type thereof of a mounted fuel cartridge. The information processing apparatus system of the present invention has an information processing apparatus for processing information, having a display device displaying data, and a fuel cell unit connected to the information processing apparatus and being connectable to a fuel cartridge. The fuel cell unit described above has a fuel cell generating a power by chemical reaction, and a display unit displaying data relating to fuel in the fuel cartridge.

### CROSS-REFERENCE TO RELATED APPLICATIONS

This application claims the benefit of priority of Japanese Patent Application No. 2004-289205, filed Sep. 30, 2004, the entire contents of which are incorporated herein by reference.

### BACKGROUND

1. Field

The present invention relates to an information processing apparatus system, a fuel cell unit, and a display method thereof, and more particularly, relates to an information processing apparatus system which has a fuel cell unit and which displays fuel management information thereof, the fuel cell unit, and a display method thereof.

2. Description of the Related Art

In recent years, as a secondary battery which is one of electrical power sources used for information processing apparatuses, for example, a lithium ion battery has been used. As one of features of the secondary battery, compared to a primary battery, which is a disposable battery, for example, the secondary battery can be repeatedly used when charged by a commercial power supply.

However, since being the secondary battery, the lithium ion battery must be charged by a commercial power supply or the like.

In addition, along with significant improvement in performance of recent information processing apparatuses, electrical power consumption of information processing apparatuses tends to increase. It has been desired to increase an energy density, that is, the amount of output energy per unit volume or per unit mass, of the lithium ion battery supplying a power to information processing apparatuses. However, in consideration of the current technical situations, it is difficult to expect remarkable improvement.

On the other hand, it is said that the energy density of a fuel cell is theoretically about 10 times that of the lithium ion battery (for example, disclosed in “Fuel Cell 2004” published by Nikkei BP Inc., October 2003, pp. 49 to 50, 64). When having the volume or mass equivalent to that of the lithium ion battery, the fuel cell has a potential capacity of supplying a power for a longer time (such as 10 times longer). In addition, when a power supply time of the fuel cell is assumed to be equal to that of the lithium ion battery, the fuel cell has a potential capacity of reducing the size and weight thereof as compared to the lithium ion battery.

In addition, in the fuel cell, when a fuel such as methanol is filled in a small container to form a fuel unit, and the fuel unit is exchanged for a new one when the fuel runs out, it is not necessary to charge the fuel cell by an external power supply. Hence, for example, in a place at which AC power facilities are not provided, compared to the case in which a power is ensured by the lithium ion battery, when a power is ensured by the fuel cell, an information processing apparatus can be used for a longer period of time.

Furthermore, when an information processing apparatus (such as a notebook type personal computer) provided with a lithium ion battery is used for a long period of time, since operation cannot be performed for a long time only by a power supplied from the lithium ion battery, the information processing apparatus must be used limitedly at a place at which an AC power source is available. However, the information processing apparatus can be used for a long period of time when a power is ensured by a fuel cell, and in addition, it can be expected that the limitation caused by the lithium ion battery is not applied to the case of the fuel cell.

From the above points of view, research and development of fuel cells attempting to supply powers to information processing apparatuses has been carried out, and for example, proposals have been disclosed in Japanese Patent Publication Nos. 2003-142137 and 2002-169629.

Among various types of fuel cells (such as those disclosed by K. Ikeda in “Everything about Fuel Cell” published by Nippon Jitsugyo Publishing Co., Ltd., August 2001), as a fuel cell suitably applied to information processing apparatuses, a DMFC method cell may be mentioned in consideration of compactness, light weight, easy fuel handling, and the like. In this type of fuel cell, methanol is used as a fuel and is directly supplied to a fuel electrode without converting it into hydrogen.

In the DMFC, the concentration of methanol supplied to a fuel electrode is an important issue, and when this concentration is high, the power generation efficiency is degraded, so that sufficient performance cannot be obtained. This insufficient performance is caused by a phenomenon, a so-called crossover phenomenon, in that a part of methanol used as a fuel pass through an electrolyte film (solid polymer electrolyte film) provided between a fuel electrode (negative electrode) and an air electrode (positive electrode). The crossover phenomenon becomes remarkable when the concentration of methanol is high, and when methanol of low concentration is supplied to the fuel electrode, the above phenomenon is suppressed.

When methanol of low concentration is used as a fuel, high performance is easily ensured. However, the volume of fuel is increased (such as 10 times larger) compared to the case of methanol of high concentration, and as a result, the size of a fuel container (fuel cartridge) is inevitably increased.

Accordingly, in a system in which the size of the fuel cartridge is reduced by using methanol of high concentration, and in which before the methanol is supplied to a fuel electrode, the concentration thereof is decreased by circulating water produced in power generation using small pumps, valves or the like, the crossover phenomenon can be suppressed. By the system described above, the power generation efficiency can be improved. Hereinafter, the pumps, valves and the like used for circulation are collectively called an auxiliary device, and in addition, the system for circulation is called a dilution circulating system.

As described above, while the size and the weight of a fuel cell unit are reduced as a whole, a fuel cell unit having high power generation efficiency can be realized by using methanol at a diluted low concentration, (see “Fuel Cell 2004” published by Nikkei BP Inc., October 2003, pp. 49 to 50, 64).

In general, when an external power source unit is connected to an information processing apparatus, it is significantly important that the power source unit is compatible with the information processing apparatus.

Furthermore, when the power source unit to be connected to the information processing apparatus is a fuel cell unit, the fuel management, such as the compatibility of fuel, a residual quantity thereof, and the like, is increasingly important.

In particular, in a fuel cell, the fuel itself is consumed as power generation is performed, and hence supply of the fuel is required. Accordingly, the structure has been widely used in which a fuel is contained in a fuel cartridge or the like and in which this fuel cartridge is detachably mounted to a fuel cell unit.

When this cartridge type fuel is used, various cases may be considered: a fuel cartridge is mounted in which a fuel is not fully consumed (for example, a fuel cartridge mounted to another fuel cell unit is used), a fuel cartridge containing a different fuel is mounted, a fuel cartridge containing a fuel at a different concentration is mounted.

When a user exchanges a fuel cartridge for a new one or first mounts a fuel cartridge, an appropriate fuel cartridge is not always mounted, and in some cases, a wrong fuel cartridge may be mounted. In addition, even when an appropriate fuel cartridge is mounted, some user may desire to confirm in some cases whether an appropriate fuel cartridge is mounted or not.

Hence, it becomes more important to perform a precise display to inform a user of fuel management information such as a residual fuel quantity in a mounted fuel cartridge and the type of fuel. In addition, without taking time to start up an information processing apparatus, it is desired that the fuel management information is rapidly displayed right after a fuel cartridge is mounted to a fuel cell unit.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing the appearance (the state in which a panel unit is opened) of one embodiment of an information processing apparatus system according to the present invention;

FIG. 2 is a perspective view showing the appearance of one embodiment of a fuel cell unit to be connected to an information processing apparatus system according to the present invention;

FIG. 3 is a perspective view showing the appearance (the state in which a panel unit is closed) of one embodiment of an information processing apparatus system according to the present invention;

FIG. 4 is a perspective view showing the appearance of an information processing apparatus of an information processing apparatus system according to the present invention, the apparatus being viewed from the bottom side thereof;

FIG. 5 is a schematic cross-sectional view of a fuel cell illustrating an operation principle of power generation by a fuel cell;

FIG. 6 is a schematic diagram primarily showing a power generation unit of a fuel cell unit of an information processing apparatus system according to the present invention;

FIG. 7 is a schematic diagram primarily showing a fuel cell control unit of a fuel cell unit of an information processing apparatus system according to the present invention;

FIG. 8 is a schematic view showing one display example of fuel management information in a fuel cell unit of an information processing apparatus system according to the present invention; and

FIG. 9 is a schematic view showing one display example of fuel management information in an information processing apparatus of an information processing apparatus system according to the present invention.

### DETAILED DESCRIPTION

Embodiments of an information processing apparatus system according to the present invention and a display method thereof will be described with reference to accompanying drawings.

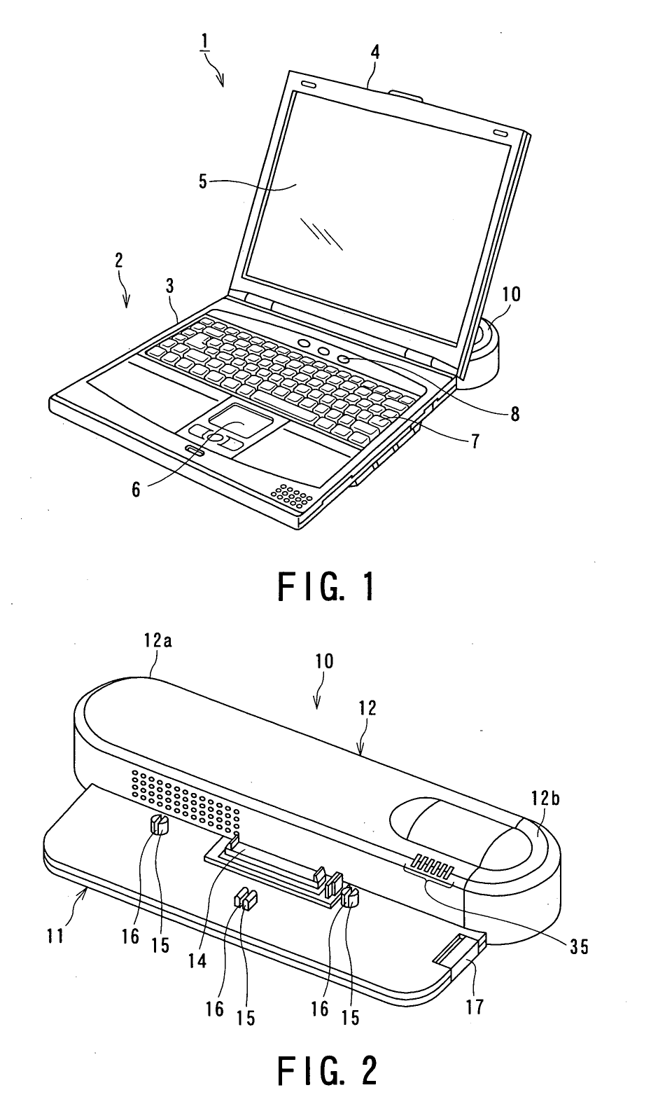

FIG. 1 is a perspective view showing the appearance of one embodiment of an information processing apparatus system 1 according to the present invention.

The information processing apparatus system 1 is formed of an information processing apparatus 2 for processing various types of information, and a fuel cell unit 10 which is connected to the information processing apparatus 2 and which supplies a power thereto.

The information processing apparatus 2 is an information processing apparatus for processing various types of information, and for example, a notebook type personal computer shown in FIG. 1 may be mentioned.

The information processing apparatus 2 has a main body unit 3 and a panel unit 4 which can be freely opened and closed. The panel unit 4 has a display device 5 formed, for example, of an LCD.

In addition, on the upper surface of the main body unit 3, a pointer device 6, a keyboard 7, a power switch 8, and the like are provided.

FIG. 2 is a perspective view showing the appearance of one embodiment of the fuel cell unit 10 which is to be connected to the information processing apparatus 2. As shown in FIG. 2, the fuel cell unit 10 is formed of a fuel cell-unit main body 12 and a placement unit 11 on which a back side of the information processing apparatus 2 is placed. The fuel cell-unit main body 12 includes a DMFC stack generating a power by electrochemical reaction and an auxiliary device (including pumps, valves and the like) feeding methanol and air used as fuel to the DMFC stack and circulating them.

In addition, in a unit case 12a of the fuel cell-unit main body 12, for example, in the right end thereof shown in FIG. 2, a fuel cartridge (not shown) which is a detachable fuel container is placed, and for exchanging this fuel cartridge, a cover 12b is dismountable.

At the right end portion of the unit case 12a shown in FIG. 2, a display unit 35 is provided which displays various states of the fuel cell unit 10 and management information (data) of fuel contained in the fuel cartridge. The display unit 35 is formed, for example, of a plurality of LEDs.

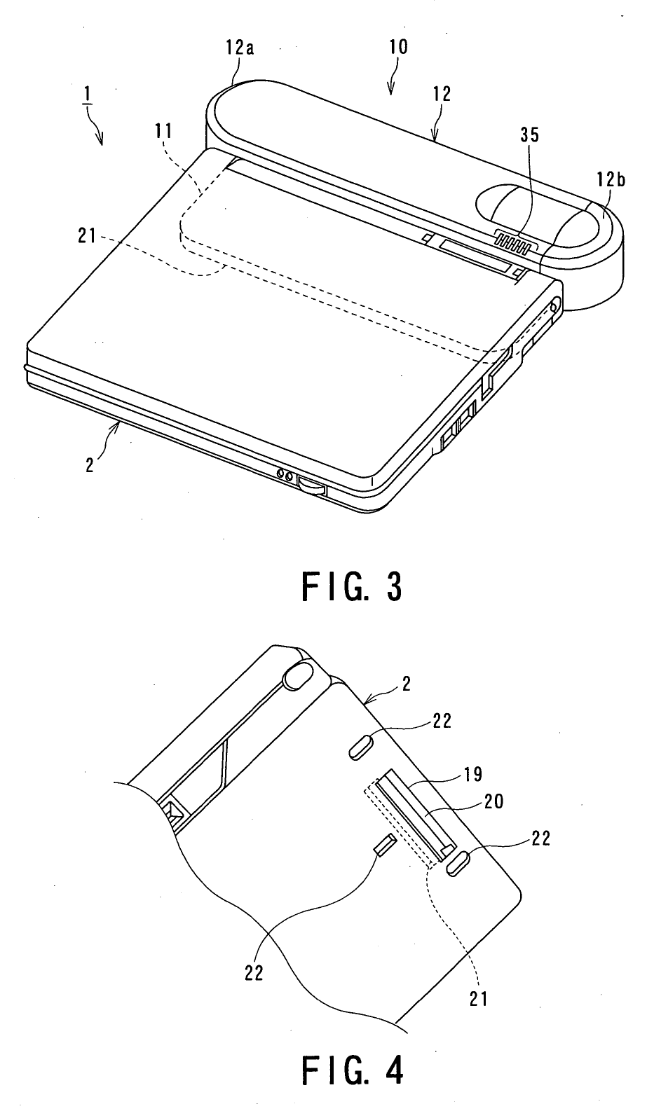

On the placement unit 11, the information processing apparatus 2 is placed. FIG. 3 is a perspective view showing the appearance of the information processing apparatus 2 placed on and connected to the fuel cell unit 10.

The information processing apparatus 2 is electrically and mechanically connected to the fuel cell unit 10 via connectors. On the upper surface of the placement unit 11 shown in FIG. 2, a single connector functioning as a connection unit is provided which is to be electrically and mechanically connected to the information processing apparatus 2. Hereinafter, this connector is called a docking connector 14.

Incidentally, for the purpose of expanding the functionality of the information processing apparatus 2, a device connectable thereto is called a docking station or docker in some cases. As the docker, besides a device including a hard disc for expanding functions, for example, there may be mentioned a device having the same connector as that of an external connector of the information processing apparatus 2 in order to facilitate the connection with an external peripheral device such as a printer (this type of docker may be called a port replicator in some cases). The fuel cell unit 10 resembles the docker described above in mechanical point of view and hence may be called a docker type fuel cell unit in some cases.

At each of three places around the docking connector 14 provided on the placement unit 11 of the fuel cell unit 10 shown in FIG. 2, a positioning protrusion 15 and hook 16 are disposed.

FIG. 4 is a schematic view showing the appearance of the back side of the bottom surface of the information processing apparatus 2, and an opening 19 is provided in the bottom surface of the information processing apparatus 2 at a place corresponding to the docking connector 14 of the fuel cell unit 10. Inside the opening 19, a docking connector 21 is disposed which functions as a connection unit of the information processing apparatus 2, and when the information processing apparatus 2 is placed on the placement unit 11 of the fuel cell unit 10, the docking connectors 21 and 14 are engaged with each other. In addition, for the opening 19 of the information processing apparatus 2, a shutter 20 is provided for dust protection, and when the information processing apparatus 2 is placed, the shutter 20 is opened.

Furthermore, in the bottom surface of the information processing apparatus 2, holes 22 are provided around the opening 19, and into each of the holes 22, the positioning protrusion 15 and hook 16 of the fuel cell unit 10 are to be inserted. The hooks 16 are provided to fix the fuel cell unit 10 to the information processing apparatus 2 after the information processing apparatus 2 is placed on the fuel cell unit 10, and when the information processing apparatus 2 is placed on the fuel cell unit 10, by a locking mechanism (not shown) inside the placement unit 11, the two parties are locked to each other; hence, the information processing apparatus 2 is fitted to the fuel cell unit 10.

When the information processing apparatus 2 is dismounted from the fuel cell unit 10, by pushing an eject button 17, the locking mechanism is released, so that the information processing apparatus 2 is easily dismounted.

As the shapes and sizes of the information processing apparatus 2 and the fuel cell unit 10 shown in FIGS. 1 to 4, the shape and the location of the docking connector 14, and the like, various structures may be considered.

In addition, without using the docking connectors 14 and 21, the fuel cell unit 10 may be integrally formed with the information processing apparatus 2 so as to be electrically connected internally therewith.

Next, the operation principle of the fuel cell of the fuel cell unit 10 connected to the information processing apparatus 2 will be described.

Since the operation principle itself has already been described in detail in published literatures (such as “Fuel Cell 2004” published by Nikkei BP Inc., October 2003, pp. 49 to 50, 64), in this embodiment, the outline of the principle will be described.

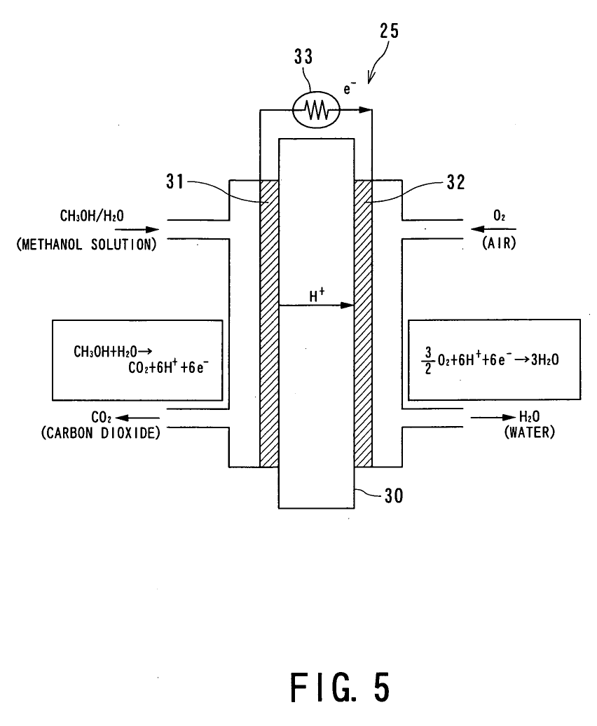

FIG. 5 is a schematic cross-sectional view of a DMFC cell 25 for illustrating the operation principle, the DMFC cell 25 being one type of fuel cell forming the fuel cell unit 10. The DMFC cell 25 has the structure composed of a fuel electrode (negative electrode) 31 and an air electrode (positive electrode) 32 with an electrolyte film 30 provided therebetween.

In the DMFC cell 25, when an aqueous methanol solution is charged to the fuel electrode 31, oxidation of methanol occurs at the fuel electrode 31, and as a result, electrons (e⁻), hydrogen ions (H⁺), and carbon dioxide (CO₂) are produced. Of the above products, hydrogen ions (H⁺) pass through the electrolyte film 30 and reach the air electrode 32. In addition, CO₂ are discharged from the other end of the fuel electrode 31.

On the other hand, electrons (e⁻) flow from the fuel electrode 31 into the air electrode 32 via a load 33. By this flow of electrons, a power is supplied outside. At the air electrode 32, O₂ contained in air supplied from the outside is reduced by hydrogen ions (H⁺) passing through the electrolyte film 30 and electrons (e⁻) flowing via the load 33, so that water (water vapor) is produced.

FIG. 5 shows one unit forming a DMFC and is called the DMFC cell 25. Practically, the DMFC cells 25 are stacked one over the other so as to obtain a predetermined voltage or current. The DMFC cells 25 thus stacked are called a DMFC stack.

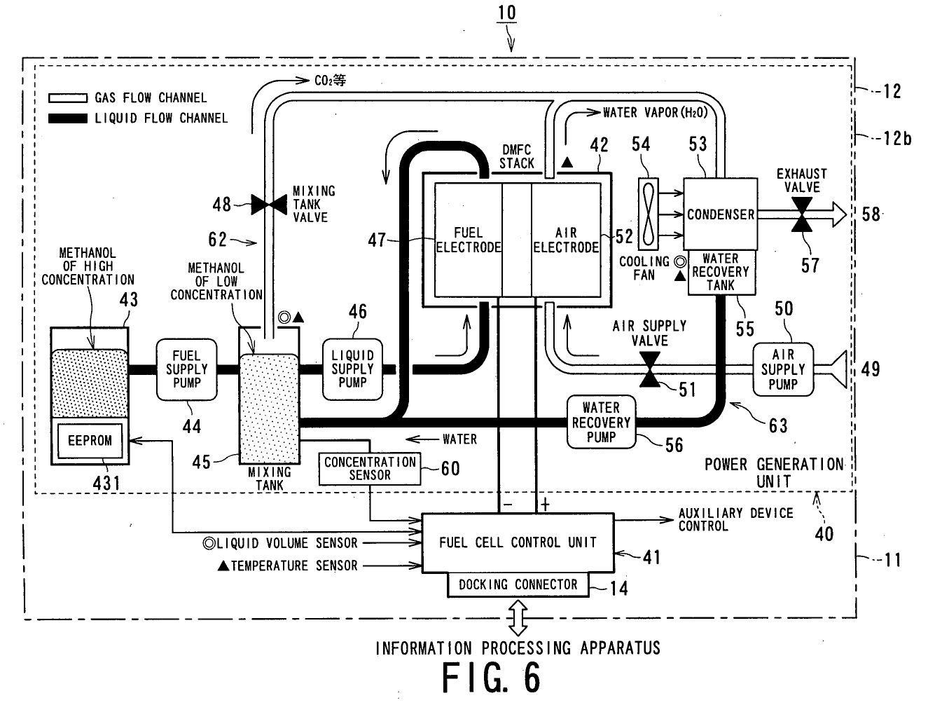

FIG. 6 is a system diagram showing the structure of the fuel cell unit 10 to be connected to the information processing apparatus 2 of the present invention, and in particular, a power generation unit 40 of the fuel cell unit 10 is shown in detail.

The fuel cell unit 10 is formed of the power generation unit 40 and a fuel cell control unit 41 controlling the fuel cell unit 10. Besides the control of the power generation unit 40, the fuel cell control unit 41 has a communication function communicating with the information processing apparatus 2.

The power generation unit 40 has a DMFC stack 42 primarily responsible for power generation and, in addition, a fuel cartridge 43 containing methanol used as a fuel. In the fuel cartridge 43, methanol of high concentration is contained. The fuel cartridge 43 is detachable so as to be easily exchanged when the fuel runs out.

The fuel cartridge 43 includes an EEPROM device 431. The EEPROM 431 stores fuel management information such as the type of fuel.

In general, in the direct methanol fuel cell, the crossover phenomenon must be suppressed in order to improve the power generation efficiency, and hence it is effective that methanol of high concentration is diluted and is then supplied to a fuel electrode 47. For this purpose, the fuel cell unit 10 employs a dilution circulating system 62, and the power generation unit 40 has an auxiliary device 63 necessary for diluting methanol of high concentration. In particular, for example, the auxiliary device 63 is formed of a fuel supply pump 44, a mixing tank 45, a liquid supply pump 46, a mixing tank valve 48, an air supply pump 50, an air supply valve 51, a condenser 53, a cooling fan 54, a water recovery tank 55, a water recovery pump 56, and an exhaust valve 57, which are connected to each other by plumbing.

The outline of the generation mechanism of the power generation unit 40 of the fuel cell unit 10 is as follows.

First, methanol of high concentration in the fuel cartridge 43 flows into the mixing tank 45 by the fuel supply pump 44. The methanol of high concentration inside the mixing tank 45 is diluted by mixing with recovered water, methanol of low concentration (residue after power generation reaction) from the fuel electrode 47, and the like, and as a result, methanol of low concentration is prepared. The methanol of low concentration is controlled to have a concentration (such as 3% to 6%) which can ensure a high power generation efficiency. This control is performed, for example, by controlling the amount of methanol of high concentration supplied to the mixing tank 45 by the fuel supply pump 44 based on the information of a concentration sensor 60. Alternatively, the control may be performed by controlling the amount of water circulated into the mixing tank 45 by the water recovery pump 56 or the like.

An aqueous methanol solution diluted in the mixing tank 45 is pressurized by the liquid supply pump 46 and is then supplied to the fuel electrode (negative electrode) 47 of the DMFC stack 42. At the fuel electrode 47, electrons (e⁻) are generated through oxidation reaction of methanol. Hydrogen ions (H⁺) generated by the oxidation reaction pass through the DMFC stack 42 and reach an air electrode (positive electrode) 52.

In addition, CO₂ produced by the oxidation reaction at the fuel electrode 47 is again circulated into the mixing tank 45 together with the methanol solution which is not used for the reaction. CO₂ is vaporized in the mixing tank 45, is then supplied to the condenser 53 via the mixing tank valve 48, and is finally discharged outside of an exhaust port 58 via the exhaust valve 57.

On the other hand, air (oxygen) is taken from a suction port 49, is then pressurized by the air supply pump 50, and is supplied to the air electrode (positive electrode) 52 via the air supply valve 51. At the air electrode 52, reduction reaction of oxygen (O₂) proceeds, and as a result, water is produced in the form of water vapor from electrons (e⁻) supplied via the external load, hydrogen ions (H⁺) from the fuel electrode 47, and oxygen (O₂). This water vapor enters the condenser 53 from the air electrode 52. In the condenser 53, the water vapor is cooled into water (liquid) by the cooling fan 54 and is then temporarily stored in the water recovery tank 55. The recovered water is circulated into the mixing tank 45 by the water recovery pump 56, so that the dilution circulating system 62 diluting methanol of high concentration is formed.

In the fuel cell unit 10, since methanol of high concentration used as a fuel is contained in the fuel cartridge 43, and the fuel cartridge 43 itself is formed detachable, when the fuel in the fuel cartridge 43 is totally consumed, the fuel is easily supplied when a user exchanges the empty fuel cartridge 43 for a new one. Accordingly, it is assumed that the fuel cell cartridges 43 are always available on the market.

However, in the situation described above, it may occur in some cases that incompatible and inappropriate fuel cartridges for different type fuel cell units are to be used. Hence, in cases in which incompatible and inappropriate fuel cartridges are used by mistake, a method for rejecting the above unwanted fuel cartridges is required.

The concentration of methanol contained in the fuel cartridge 43 is high, such as 100%, for general application; however, when the fuel cell unit 10 is first used, the fuel cartridge 43 to be mounted thereto is required to contain methanol of low concentration.

In the dilution circulating system 62 shown in FIG. 6, the structure is formed so that methanol of high concentration is diluted in the mixing tank 45, and in the mixing tank 45, the methanol is diluted to have a low concentration, such as one mole per liter.

When the fuel cell unit 10 is first used or is used after the maintenance, diluted methanol may not be present in the mixing tank 45 in some cases. In the case described above, it is required that after the fuel cartridge 43 that contains methanol of low concentration is mounted to the fuel cell unit 10, the mixing tank 45 be filled with methanol of low concentration by driving the fuel supply pump 44.

That is, at least two types of methanol in terms of concentration are contained in the fuel cartridges 43: methanol of high concentration of approximately 100% for general use, and methanol of low concentration of approximately one mole per liter for the initial use. Hence, there are two types of fuel cartridges 43 having different methanol concentrations.

In addition, in high-temperature and low-humidity conditions such as in a desert area, water moisture is vaporized at a significantly high rate as compare to that in general use conditions, and as a result, when methanol of high concentration of approximately 100% is used, the concentration thereof may not be appropriately decreased in some cases. Hence, in the case described above, it may be required in some cases that the concentration of methanol contained in the fuel cartridge 43 be decreased to a medium high level, such as approximately 80%.

As described above, it may occur in some cases that methanol solutions having different concentrations be contained in the fuel cartridges 43, and hence in accordance with the use conditions (whether being initial use or general use) or the use environment (whether being used under general conditions or high-temperature and low-humidity conditions), it is necessary to use the fuel cartridge 43 that contains a fuel at an appropriate concentration.

As described above, the concentration of the fuel contained in the fuel cartridge 43 and the type thereof are quite important as fuel management information, and hence at the stage in which the fuel cartridge 43 is mounted to the fuel cell unit 10, a display function is required which rapidly and appropriately informs a user of the fuel management information mentioned above.

As a method for realizing the display function described above, the following method is very effective. That is, the EEPROM 431 is provided for the fuel cartridge 43, the fuel management information, such as the concentration of fuel and the type thereof, is stored in the EEPROM 431 beforehand, the fuel cell unit 10 reads and identifies the fuel management information described above at the stage in which the fuel cartridge 43 is mounted to this fuel cell unit 10, and the fuel management information is displayed in the display unit 35 thereof.

In addition, after the information processing apparatus 2 is started up, it is also very effective to enable the display device 5 of the information processing apparatus 2 to display more detailed information (data).

In addition, the case may also be considered in which the fuel cartridge 43 is used after being partly used (such as the case in which a fuel cartridge mounted to one fuel cell unit is removed and is then mounted to another fuel cell unit). In the case described above, the residual quantity of fuel is also very important fuel management information. The reason for this is that when appropriate information on the residual quantity of fuel is displayed and is informed to a user, the time to exchange the fuel cartridge 43 may be estimated by the user.

In the case of displaying the residual quantity of fuel, there may be a method directly displaying the residual quantity of fuel; however, in addition to that, another method may also be considered in which a remaining usable time is displayed. For example, even when the fuel cartridge 43 that contains a fuel at a high concentration of 100% and the fuel cartridge 43 that contains a fuel at a concentration of 80% have the same residual fuel quantity, the remaining usable times thereof are different from each other. As described above, when the various types of fuel cartridges 43 are present on the market at the same time, compared to the information on the residual quantity of fuel, the information on remaining usable time may be advantageous to a user in some cases.

In order to realize a display function displaying the above fuel management information, the fuel cell unit 10 is formed so that the fuel management information including the concentration, the type, and the residual quantity of fuel is stored in the EEPROM 431 embedded in the fuel cartridge 43 and is easily read by the fuel cell unit 10 when the fuel cartridge 43 is mounted thereto.

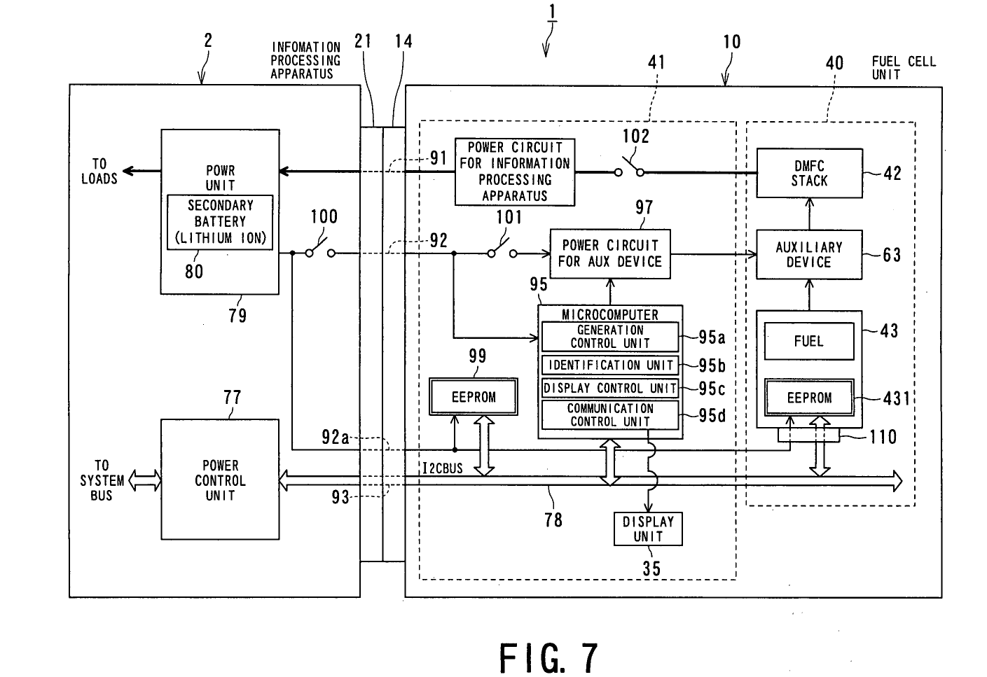

FIG. 7 is a system diagram showing the structure of the fuel cell unit 10 to which the fuel cartridge 43 is mounted, the information processing apparatus 2 connected to the fuel cell unit 10, and an interface unit therebetween. With reference to FIG. 7, the structure and operation of the fuel cell unit 10 and the information processing apparatus 2 will be described.

The information processing apparatus 2 and the fuel cell unit 10 are mechanically and electrically connected to each other using respective single connectors, that is, the docking connectors 14 and 21. The power generated in the DMFC stack 42 of the fuel cell unit 10 is supplied to the information processing apparatus 2 through an output power terminal 91 of the docking connectors 14 and 21. In addition, from a power unit 79 of the information processing apparatus 2, a power is supplied to a power circuit for auxiliary device 97 via a switch 100, an input power terminal 92 for the auxiliary device, and a switch 101. In addition, from the input power terminal 92, a power is supplied to a microcomputer 95.

The microcomputer 95 is the major part of the fuel cell control unit 41 and functions as an identification unit 95b reading and identifying the fuel management information stored in the EEPROM 431 of the fuel cartridge 43 besides the function as a generation control unit 95a controlling the power generation of the power generation unit 40.

In addition, the microcomputer 95 also functions as a display control unit 95c controlling the display of the fuel management information identified by the identification unit 95b, the display being performed on the display unit 35 of the fuel cell unit 10.

Furthermore, the microcomputer 95 also functions as a communication control unit 95d communicating with the information processing apparatus 2.

Next, with reference to FIG. 7, a process flow will be described starting from the reading and identification of the fuel management information of the fuel cartridge 43 of the fuel cell unit 10 to the display of the fuel management information on the display unit 35 of the fuel cell unit 10 and on the display device 5 of the information processing apparatus 2.

In this process flow, it is assumed that the information processing apparatus 2 has a chargeable and dischargeable secondary battery 80 formed of a lithium ion battery or the like and that this secondary battery is charged to a predetermined electrical power level. In addition, it is also assumed that all the switches in FIG. 7 are being opened.

When the docking connectors 14 and 21 are mechanically connected to each other, a power is supplied to an EEPROM 99 of the fuel cell control unit 41 via a power terminal 92a. In this EEPROM 99, identification information of the fuel cell unit 10 is stored beforehand. In the identification information, for example, a part code, a production serial number, and/or a rated output of the fuel cell unit 10 may be included.

In addition, this EEPROM 99 is connected to a power control unit 77 of the information processing apparatus 2, for example, with a serial bus I2C bus 78 via a communication input/output terminal 93 provided in the docking connectors 14 and 21. When a power is supplied to the EEPROM 99 by connection between the docking connectors 14 and 21, the data stored in the EEPROM 99 can be read by the power control unit 77. In the structure shown in FIG. 7, the power control unit 77 can read the information of the EEPROM 99 through the communication input/output terminal 93 of the docking connectors 14 and 21, and hence it is identified that the connected fuel cell unit 10 is compatible and appropriate member.

At the same time when supplied to the EEPROM 99 via the power terminal 92a, a power is also supplied to the EEPROM 431 of the fuel cartridge 43. Hence, when the docking connectors 14 and 21 are connected to each other, and a power is supplied from the secondary battery 80 of the information processing apparatus 2 to the fuel cell unit 10, besides the EEPROM 99, the EEPROM 431 of the fuel cartridge 43 is also placed in an operable state.

As shown in FIG. 7, the EEPROM 431 of the fuel cartridge 43 is connected to the I2C bus 78 of the fuel cell unit 10 via a communication input/output terminal 110.

When the compatibility of the fuel cell unit 10 is confirmed from the identification information of the fuel cell unit 10 stored in the EEPROM 99 beforehand, the information processing apparatus 2 closes the switch 100 so as to supply a power of the secondary battery 80 to the fuel cell unit 10 via the input power terminal 92.

In this stage, the microcomputer 95 of the fuel cell unit 10 is placed in an operable state.

The identification unit 95b of the microcomputer 95 reads the fuel management information stored in the EEPROM 431 of the fuel cartridge 43 through the I2C bus 78, and for example, the type, concentration, residual quantity of the fuel are identified.

Next, the display control unit 95c of the microcomputer 95 enables the display unit 35 of the fuel cell unit 10 to display the identified fuel management information.

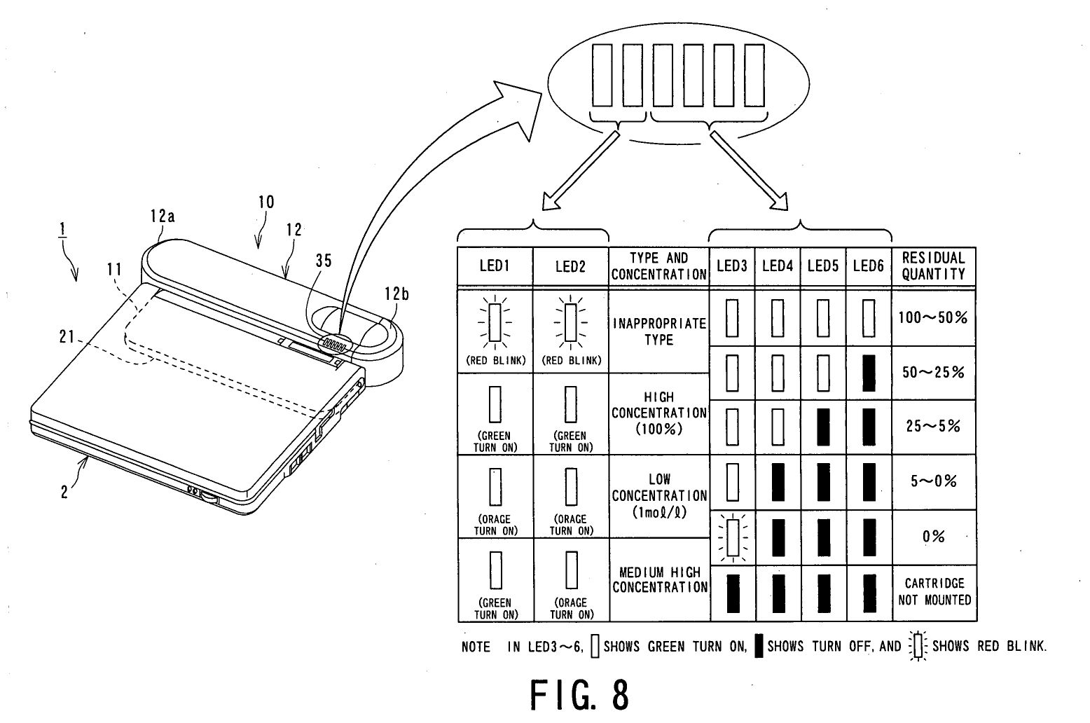

FIG. 8 shows a display example of the fuel management information displayed in the display unit 35. The display unit 35 is formed, for example, of six LEDs, that is, LED 1 to LED 6.

LEDs 1 and 2 display the compatibility of the type of fuel and the concentration thereof.

When the fuel cartridge 43 that contains an inappropriate type of fuel is mounted to the fuel cell unit 10, both LEDs 1 and 2 are allowed to blink on and off in red so as to call a user's attention. When the fuel cartridge 43 that is compatible with the fuel cell unit 10 and that contains methanol of high concentration (such as 100%) for general use is mounted, both LEDs 1 and 2 are turned on in green. In addition, when the fuel cartridge 43 that is compatible with the fuel cell unit 10 and that contains methanol of low concentration (such as 1 mole/liter) for initial use is mounted, both LEDs 1 and 2 are turned on in orange.

In addition, for example, when the fuel cartridge 43 that contains a fuel at a medium high concentration for high-temperature and low-humidity conditions is mounted, LED 1 is turned on in green, and LED 2 is turned on in orange.

LEDs 3 to 6 display the residual quantity of a fuel of the mounted fuel cartridge 43. For example, when the residual quantity is in the range of 100% to 50%, all LEDs 3 to 6 are turned on in green, and as the residual quantity is decreased, the number of LEDs which are turned on is decreased as shown in FIG. 8. When the residual quantity reaches zero, LED 3 is only allowed to blink on and off and the other LEDs 4 to 6 are turned off. In addition, when the fuel cartridge 43 is not mounted, all LEDs 3 to 6 are turned off.

The display method described above is merely one example of the LED display, and the display method of the present invention is not limited thereto.

In addition, the fuel management information stored in the EEPROM 431 of the fuel cartridge 43 can also be displayed in the display device 5 of the information processing apparatus 2.

As shown in FIG. 7, the I2C bus 78 is connected to the power control unit 77 of the information processing apparatus 2 via the communication input/output terminal 93 provided in the docking connectors 14 and 21. The power control unit 77 is further connected to a system bus in the information processing apparatus 2, and through this system bus, the fuel management information can be displayed in the display device 5 of the information processing apparatus 2 by a known technique.

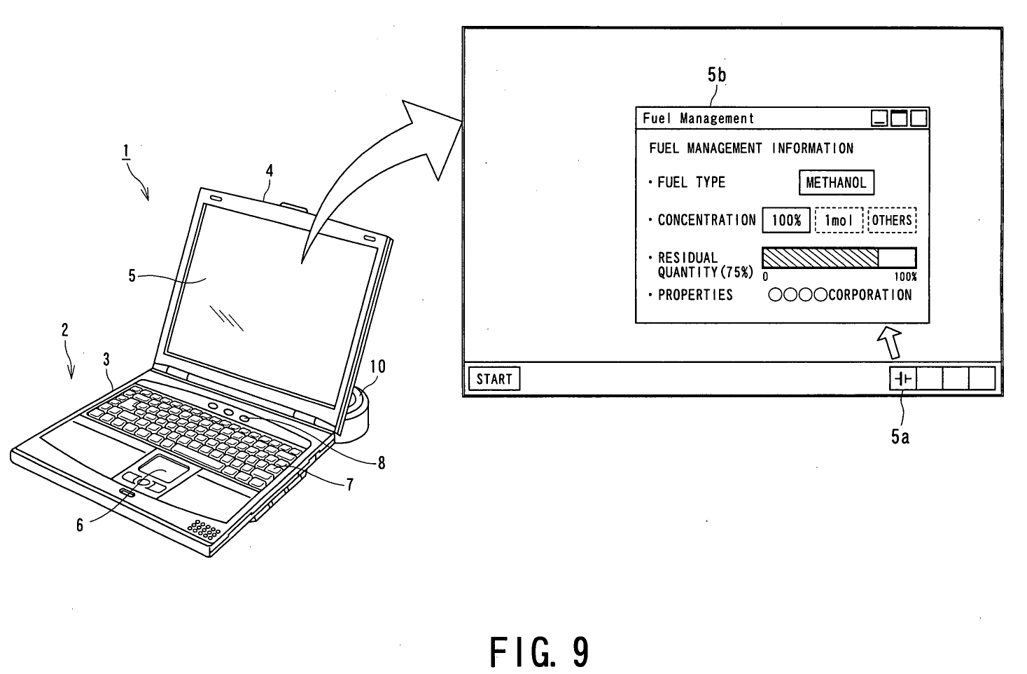

FIG. 9 is a view showing an example in which the fuel management information is displayed in the display device 5 of the information processing apparatus 2.

The fuel management information is displayed in a fuel information window 5b, for example, by clicking a fuel cell icon 5a displayed in a task bar of the display device 5, and in this fuel information window 5b, various types of fuel management information are displayed. The fuel management information thus displayed includes the fuel type, fuel concentration, and residual quantity of fuel.

In addition, detailed information on the properties of fuel, such as a producer of the fuel cartridge 43, the types of additives contained in fuel, and the like may also be displayed.

Furthermore, besides the display of the fuel management information, when the fuel cartridge 43 that contains a wrong type of fuel or a fuel at an inappropriate concentration is mounted to the fuel cell unit 10, alarm may be displayed in order to call a user's attention. By comparing with the information on an appropriate type and concentration of fuel stored beforehand, it can be judged whether the fuel cartridge 43 that contains a wrong type of fuel or a fuel at an inappropriate concentration is mounted or not.

A method for displaying the alarm is not particularly limited, and for example, it is possible to call a user's attention by allowing the fuel cell icon 5a of the task bar to blink on and off.

The power generation of the fuel cell unit 10 is started when the microcomputer 95 receives an operation-start command from the power control unit 77 of the information processing apparatus 2. When the communication control unit 95d of the microcomputer 95 receives the operation-start command, the generation control unit 95a of the microcomputer 95 closes the switch 101 so as to supply a power to the power circuit for auxiliary device 97, thereby driving the auxiliary device 63. As shown in FIG. 6, the auxiliary device 63 is formed, for example, of the pumps 44, 46, 50, and 56, the valves 48, 51, and 57, and the cooling fan 54. By driving the auxiliary device 63, the fuel (aqueous methanol solution) and air (oxygen) are supplied to the fuel electrode 47 and the air electrode 52 of the DMFC stack 42, respectively, and subsequently, the power generation by the DMFC stack 42 is started. Furthermore, the generation control unit 95a of the microcomputer 95 closes the switch 102, and the supply of the generated power to the information processing apparatus 2 is started through the output power terminal 91.

As described above, according to the information processing apparatus system 1 of the present invention and the display method thereof, even before the fuel cell unit 10 generates a power, or even before the information processing apparatus 2 is started up, the fuel management information such as the residual quantity of fuel and the type thereof can be precisely and rapidly displayed in the display unit 35 of the fuel cell unit 10. As a result, right after the fuel cartridge 43 is mounted, a user can confirm the fuel management information of the mounted fuel cartridge 43; hence, the fuel cartridge 43 that is inappropriate can be prevented from being used, and in addition, the residual quantity in the fuel cartridge 43 can also be understood.

In addition, after the information processing apparatus 2 is started up, more detailed fuel management information can also be displayed in the display device 5 of the information processing apparatus 2.

It is to be naturally understood that the present invention is not limited to the above embodiments, and the constituent elements described above may be optionally changed and modified without departing from the scope of the present invention. In addition, the constituent elements disclosed in the above embodiments may be variously used in combination to form various structures within the scope of the present invention. For example, several constituent elements of all the constituent elements of the above embodiments may be removed. Furthermore, the constituent elements used in the different embodiments may be appropriately combined with each other.

What is claimed is:

1. An information processing apparatus system comprising:
an information processing apparatus which processes information, comprising;
a display device which displays data; and
a fuel cell unit connected to the information processing apparatus and being connectable to a fuel cartridge, comprising:
a fuel cell which generates a power by chemical reaction; and
a display unit which displays data relating to fuel in the fuel cartridge.

2. The information processing apparatus system according to claim 1, wherein the fuel cartridge includes a memory which stores the data relating to the fuel, and the display unit displays the data stored in the memory.

3. The information processing apparatus system according to claim 2, the fuel cell unit further comprising a control unit which reads the data relating to the fuel in the fuel cartridge, wherein the display unit displays the data read by the control unit.

4. The information processing apparatus system according to claim 1, wherein the data relating to the fuel includes data on a residual quantity of the fuel in the fuel cartridge.

5. The information processing apparatus system according to claim 1,
wherein the data relating to the fuel includes at least one of data on a type of the fuel in the fuel cartridge and data on concentration thereof.

6. The information processing apparatus system according to claim 1,
the fuel cell unit further comprising a control unit which reads the data relating to the fuel, and
the information processing apparatus further comprising a second control unit which receives the data from the control unit, wherein the display device displays the data received by the second control unit.

7. A fuel cell unit connected to an information processing apparatus which processes information and being connectable to a fuel cartridge, comprising:
a fuel cell which generates a power by chemical reaction; and
a display unit which displays data relating to fuel in the fuel cartridge.

8. The fuel cell unit according to claim 7,
wherein the fuel cartridge includes a memory which stores the data relating to the fuel, and the display unit displays the data stored in the memory.

9. The fuel cell unit according to claim 8, the fuel cell unit further comprising a control unit which reads the data relating to the fuel in the fuel cartridge, wherein the display unit displays the data read by the control unit.

10. The fuel cell unit according to the claim 7, wherein the data relating to the fuel includes data on a residual quantity of the fuel in the fuel cartridge.

11. The fuel cell unit according to the claim 7, wherein the data relating to the fuel includes at least one of data on a type of the fuel in the fuel cartridge and data on concentration thereof.

12. A displaying method of an information processing apparatus system: the information processing apparatus system comprising: an information processing apparatus which processes information comprising a display device which displays data; and a fuel cell unit connected to the information processing apparatus and being connectable to a fuel cartridge: comprising a fuel cell which generates a power by chemical reaction, and a display unit which displays data, the displaying method comprising:
detecting whether the fuel cartridge is connected to the fuel cell unit or not; and
displaying the data relating to fuel containable in the fuel cartridge when the fuel cartridge is connected to the fuel cell unit.

13. The displaying method of the information processing apparatus system, according to claim 12, further comprising
reading data stored in a memory included in the fuel cartridge and relating to the fuel containable in the fuel cartridge; and
wherein the displaying displays the read data.

14. The displaying method of the information processing apparatus system, according to claim 12,
wherein the data includes data on a residual quantity of the fuel in the fuel cartridge.

15. The displaying method of the information processing apparatus system, according to claim 12,
wherein the data includes at least one of data on the type of the fuel in the fuel cartridge and data on concentration thereof.

16. The displaying method of the information processing apparatus system, according to claim 12,
wherein the display device of the information processing apparatus displays the data relating to the fuel in the fuel cartridge.
